(19) United States
(12) Patent Application Publication
(10) Pub. No.: US 2009/0264099 A1
(43) Pub. Date: Oct. 22, 2009

(54) METHOD FOR AUTHENTICATION OF AT LEAST ONE MOBILE RADIO TERMINAL

(76) Inventor: Christian Csank, Grimmenstein (AT)

Correspondence Address: RATNERPRESTIA, P.O. BOX 980, VALLEY FORGE, PA, 19482, US

(21) Appl. No.: 12/294,064

(22) PCT Filed: Mar. 26, 2007
(86) PCT No.: PCT/AT07/00144

§ 371 Date: Sep. 23, 2008

(30) Foreign Application Priority Data
Mar. 29, 2006 (AT) A 537/2006

(51) Int. Cl. H04M 1/66

(52) U.S. Cl. 455/411

(57) ABSTRACT

The invention describes a method and system for the authorization of at least one mobile radio terminal with an authentication terminal. The at least one mobile radio terminal features an identification number which is stored at the authentication terminal and is assigned at least one name there and the authentication terminal scans by way of radio and checks if the identification number of the mobile radio terminal that enters into the transmission/reception range, matches the saved identification number and in case of a match, the authentication terminal initiates a connection setup with the mobile radio terminal under the assigned name of the identification number. The assigned name is displayed on the mobile radio terminal and the authentication terminal cancels the connection setup as soon as at least one of the mobile radio terminals confirms the connection setup with the authentication terminal under one of the displayed names.

The invention relates to a method for authentication of at least one mobile radio terminal with an authentication terminal, whereby the at least one mobile radio terminal features an identification number and the identification number of the at least one mobile radio terminal is stored at the authentication terminal and as soon as a mobile radio terminal enters into the authentication terminal's transmission/reception range, the authentication terminal scans by way of radio and checks if one identification number of the mobile radio terminal matches the saved identification number.

Furthermore, the invention relates to system for authentication of at least one mobile radio terminal with an authentication terminal, whereby the at least one mobile radio terminal features an identification number and the identification number of the at least one mobile radio terminal is stored at the authentication terminal and the authentication terminal is set-up to scan by means of radio and check if one identification number of the mobile radio terminal matches the saved identification number when a mobile radio terminal enters into the authentication terminal's transmission/reception range.

The DE 601 06 665 T2 describes means of the above mentioned type, whereby the authentication terminal generates an authentication key and transmits via Bluetooth connection to the mobile radio terminal. Hereafter, a concluding authentication step is performed on the basis of the transmitted authentication key at the mobile radio terminal. This known authentication means holds the disadvantage that software has to be installed at the mobile radio terminal in order to allow authentication. Further manufacturing and setup cost are incurred with this additional software.

The WO 01/23694 A1 discloses an automatic locking system, e.g. for a door lock, which authenticates a mobile device by means of an identification number. The system includes a control unit with memory, a locking unit, and a mobile unit with a specific identification number. The control unit submits a first signal; the mobile unit reacts by transmitting the identification number as soon as it enters into the transmission/reception range of the control unit. If the identification number is recognized by the control unit, i.e. if the identification number is stored in the memory of the control unit, the locking unit is deactivated. The return transmission of the mobile unit's identification number can be linked to a confirmation by the user of the mobile device. Such confirmations include entering a PIN code or pressing a certain button on the mobile device. This system holds the disadvantage that—in case there is no confirmation step requested for the authentication—the user of the mobile unit cannot know or control if and for which operations he is authenticated when entering into the transmission/reception range of the control unit. Even if the return transmission of the identification number is performed after confirmation only, the user of the mobile unit does not know for what he has been authenticated.

Therefore, it is an object of the invention to enable the simple authorization of a mobile radio terminal without the installation of additional software on the device.

In this document a mobile radio terminal encompasses all terminals that are able to exchange data by way of radio with another terminal; in particular mobile phones, personal digital assistants (PDAs), etc.

This issue is resolved with the above mentioned method according to the invention: The identification number of the at least one mobile radio transmitter is given at least one name at the authentication terminal and moreover, the authentication terminal scans and checks if an identification number of the mobile radio terminal matches the stored identification number and in case of a match, a connection setup with the mobile radio terminal is initiated under the assigned name of the identification number and the assigned name is displayed on the mobile radio terminal and the authentication terminal cancels the connection setup as soon as the at least one mobile radio terminals confirms the connection setup with the authentication terminal under one of the displayed names.

To facilitate the readability of the text, the term authentication terminal is also substituted by authentication master and instead of mobile radio terminal the term client is also used.

It is a benefit of the invention that the authorization can be conducted without mandatory upgrading the mobile radio terminal's hardware or software. The authentication terminal ensures that intrusion or authentication of untrusted third parties is prevented.

It is advantageous if an actuator is operated after the confirmation of connection setup by the mobile radio terminal. Thus, a desired operation (e.g. opening or closing of door) can be authorized after the authentication is completed, without requiring an additional prompt by the user. It is a beneficial version of the invention that the name, under which the authentication master is recognized by the client, describes an operation to be performed by the actuator. After successful authentication, the user recognizes instantly which operation is being performed if he confirms the connection setup.

Furthermore, the name of the authentication master can be modified in connection with the actuator's most recently performed operation. For example, the name “open door” can be changed to “close door”, if the last operation was the opening of the door, and vice versa.

Preferably, the identification number will be a unique device number assigned by the manufacturer. Thus, each client can be identified easily without further implementations.

Moreover, the authentication terminal can check if other mobile radio terminals are within its transmission/reception range, while connecting to the at least one mobile radio terminal. The authentication terminal can simultaneously establish one separate connection for each of several mobile radio terminals. This ensures that several clients can be operated parallel by the authentication master and no malfunction is encountered due to existing client-master connections.

The invention can be implemented easily when Bluetooth, ZigBee, or Wi-Fi radio standards are utilized for its execution. Certainly, proprietary protocols can always be utilized.

The above mentioned problem can be resolved by a system of the kind described initially, in that according to the invention the identification number of the at least one mobile radio terminal is assigned at least one name at the authentication terminal and the authentication terminal is set-up to scan or check if one identification number of the mobile radio terminal matches the saved identification number and in case of a match, it initiates a connection setup with the mobile radio terminal under the assigned name of the identification number, whereby the mobile radio terminal is set-up to display the assigned name and moreover, the authentication terminal is set-up to cancel the connection setup as soon as the at least one mobile radio terminals confirms the connection setup with the authentication terminal under one of the displayed names.

It is advantageous if the system is configured in such a way, that an actuator is operated after the confirmation of the connection setup by the mobile radio terminal.

According to the preferred embodiment of the invention the name, under which the connection with the mobile radio terminal is established, describes an operation to be performed by the actuator. Moreover, it is ideal if the system is set-up to change the name in connection with the last operation performed by the actuator.

Further advantages are achieved, if the identification number is a unique device number assigned by the manufacturer.

Moreover, the authentication terminal can be set-up to check if other mobile radio terminals are within its transmission/reception range, when it is connecting to the at least one mobile radio terminal. Preferably, the authentication terminal is set-up to establish simultaneously one separate connection for each of several mobile radio terminals.

The invention can be implemented especially easily as the authentication terminal and the at least one mobile radio terminal are setup to exchange data via Bluetooth, ZigBee, or Wi-Fi radio standards.

The invention, together with further advantages thereof, is explained in greater detail below with reference to some non-restricting exemplary embodiments illustrated in the drawings, in which:

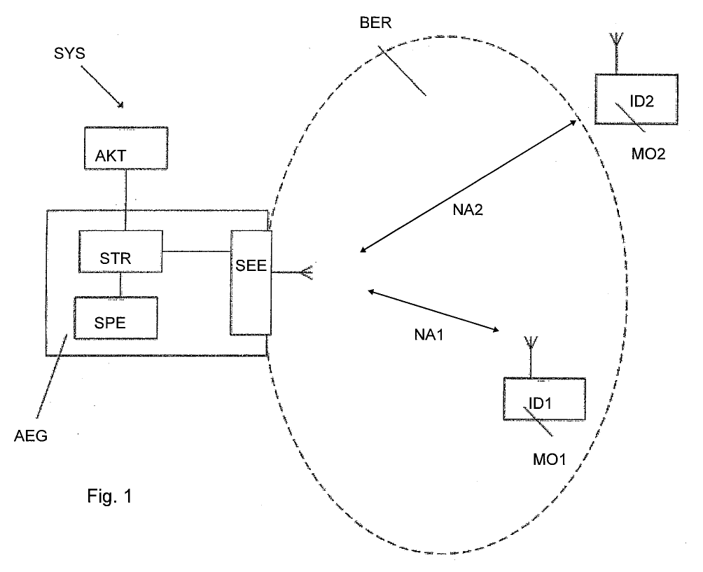

FIG. 1 is a block diagram of system according to invention;

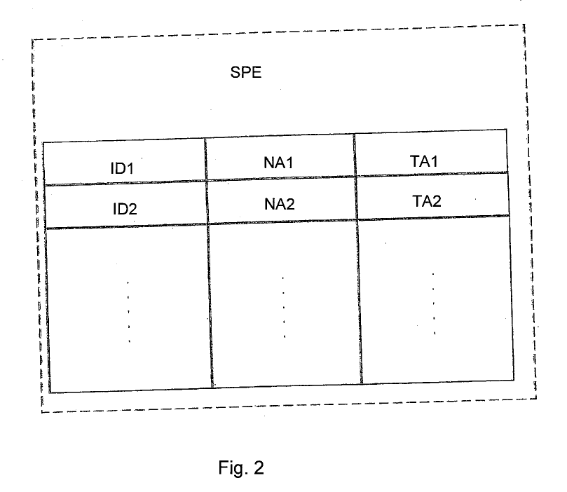

FIG. 2 shows a memory content of an authentication terminal;

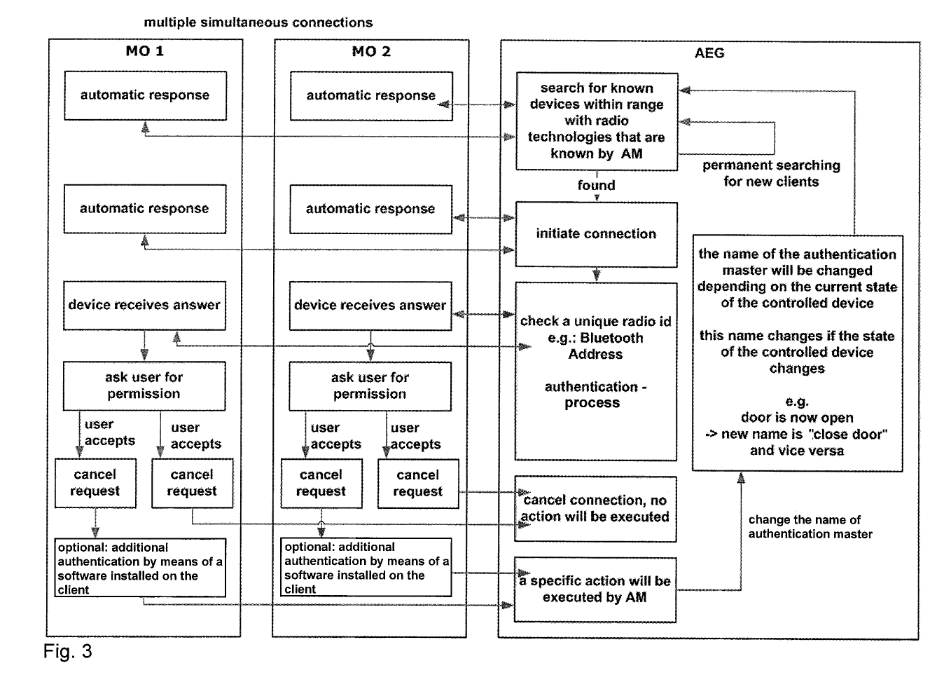

FIG. 3 illustrates a first flow chart of the method according to invention;

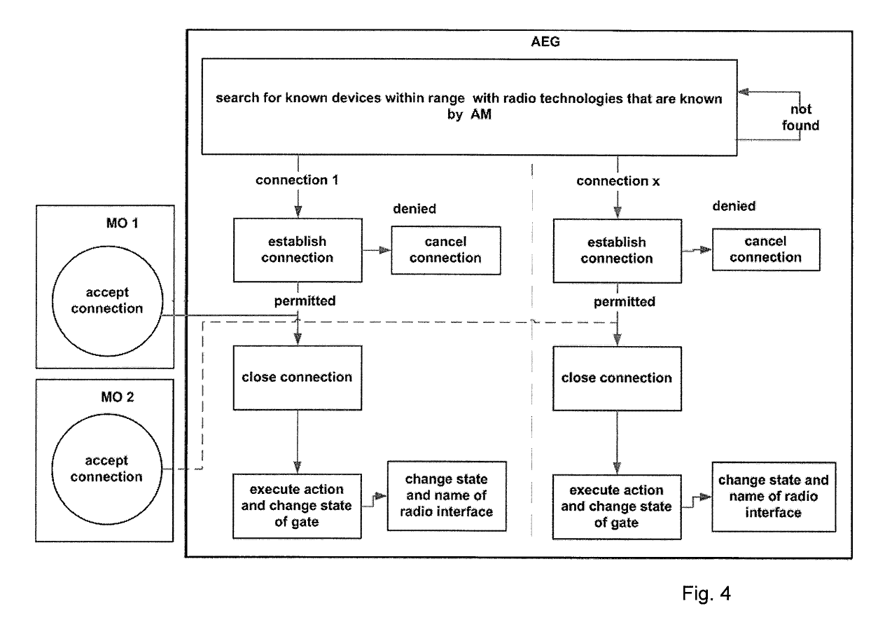

FIG. 4 shows a second flow chart of the method according to invention;

According to FIG. 1 the system SYS according to the invention features an authentication terminal AEG for the authorization of one or more mobile radio terminals MO1, MO2. Each of the mobile radio terminals MO1, MO2 has a respective identification number ID1, ID2.

The authentication terminal AEG stores the identification number ID1, ID2 of at least one authorized mobile radio terminal MO1, MO2.

FIG. 2 demonstrates that the identification number ID1, ID2 is assigned at least one name NA1, NA2 at the authentication terminal AEG.

The authentication terminal AEG is set-up to scan by way of radio and check if the identification number ID1, ID2 of the mobile radio terminal MO1, MO2, which enters into the transmission/reception range BER of the authentication terminal AEG, matches the saved identification number ID1, ID2.

In case of a match of the identification numbers ID1, ID2, the authentication master is configured to initiate a connection setup with the respective mobile radio terminal MO1, MO2 under the assigned name NA1, NA2 of the identification number ID1, ID2.

The authorized mobile radio terminal MO1, MO2 is configured to show the assigned name NA1, NA2 on the mobile radio terminal MO1, MO2, for example on a display.

Furthermore, the authentication terminal AEG is set-up to cancel the connection as soon as the at least one mobile radio terminal MO1, MO2 confirms the connection setup with the authentication terminal AEG under one of the displayed names NA1, NA2.

The authentication terminal AEG features a transmission/reception unit SEE and a control STR, such as an accordingly programmed micro processor. Further, a memory SPE is provided for the authentication terminal AEG, which contains the identification numbers ID1, ID2 and the names NA1, NA2 along with other data relevant for the operation of the invention. The authentication terminal AEG constitutes essentially a radio unit which can be integrated into any type of control system.

Also, the authentication terminal AEG is configured to operate an actuator AKT after confirmation of the connection setup by the mobile radio terminal MO1, MO2. Ideally, the name NA1, NA2 describes an operation TA1, TA2 to be performed by the actuator. The operation TA1, TA2 to be performed can also be stored in the memory SPE of the authentication terminal AEG.

Further, the authentication terminal AEG is programmed to change the names NA1, NA2 in connection with the most recently performed operation of the actuator.

In addition, the authentication terminal AEG is set-up to check if other mobile radio terminals MO1, MO2 are within its transmission/reception range and establish a simultaneous connection to these mobile radio terminals MO1, MO2, while connecting to the at least one mobile radio terminal MO1, MO2.

Preferably, the authentication terminal AEG and the mobile radio terminals MO1, MO2 are Bluetooth, ZigBee or Wi-Fi terminals.

FIGS. 3 and 4 illustrate the authorization procedure according to the invention of one or more mobile radio terminals MO1, MO2 with an authentication terminal AEG via radio authorization. Below, the mobile radio terminals MO1, MO2 will be called clients MO1, MO2 and the authentication terminal AEG authentication master AEG.

Each client MO1, MO2 receives an identification number ID1, ID2. Ideally, the identification number ID1, ID2 is a unique device number assigned by the manufacturer to the client MO1, MO2.

As soon as a client MO1, MO2 enters into the transmission/reception range BER of the authentication master AEG, the authentication master AEG requests the identification number ID1, ID2 of the client MO1, MO2 by way of radio and checks if the requested identification number ID1, ID2 matches the saved identification numbers ID1, ID2 of an authorized client.

If the identification number ID1, ID2 of a client MO1, MO2 does not match one of the saved identification numbers, the authentication master AEG will basically not initiate a connection; i.e. the authentication master AEG acts “mute” towards the non-authorized client MO1, MO2. Certainly, the authentication master AEG can also adopt a different, pre-defined behavior towards the non-authorized client MO1, MO2.

In case of matching identification numbers ID1, ID2 of the client, the authentication master AEG initiates a connection setup with the client or clients MO1, MO2. As its identity or radio address the authentication master AEG states the name NA1, NA2, which is assigned to each of the identification numbers ID1, ID2. The display of the client or clients shows the name of the receiver, i.e. as name of the authentication master AEG the respective name NA1, NA2.

Thus, for example the name NA1 assigned to the identification number ID1 can be “open door” and the name NA2 assigned to the identification number ID2 “turn on light”. When a connection is established by the authentication master AEG the display of client MO1 shows for example “Connect with ‘open door’?” while the client MO2 displays “Device ‘turn on light’ recognized. Connect with ‘turn on light’?”

If the user of the respective clients MO1, MO2 confirms the connection setup, the authentication master AEG interrupts the connection setup or connection to the respective client MO1, MO2. After confirmation of connection setup from the clients MO1, MO2 the authentication master forwards a corresponding command for the execution of an operation TA1, TA2 to the actuator AKT.

The operation TA1, TA2 to be performed by the actuator is also assigned the identification number ID1, ID2 and can be stored at the authentication master AEG. Ideally, the name NA1, NA2 describes the operation to be performed by the actuator in case of confirmation of the connection setup by a user of the clients MO1, MO2. Thus, the user notices at once which operations he initiates by confirming the connection setup, without installing additional software on the client MO1, MO2.

In short summary, the authentication master AEG performs operations only with known clients MO1, MO2 and utilizes the client's unique address ID1, ID2 (Bluetooth address . . . ); i.e. the client MO1, MO2 has to be introduced manually to the authentication master. Defined operations can be performed with unknown clients. The authentication master AEG performs operations only after manual activation on the client MO1, MO2. The authentication master AEG checks continuously with all known protocols if a client MO1, MO2 approaches; i.e. if a client MO1, MO2 enters into the reception range of AM or a signal of a client MO1, MO2 surpasses a pre-defined intensity or quality. If an authentication is required, the authentication master AEG checks if the client MO1, MO2 is known. If a confirmation is required, the authentication master AEG establishes a connection with the client MO1, MO2. If the connection setup with the client is confirmed, a respective operation is performed. If no authentication and no confirmation are necessary, the authentication master AEG performs the respective operation. The authentication master AEG can assume several conditions (e.g. door open/door closed/ . . . ) and the operation to be performed is adjusted accordingly (close door/open door). The condition is changed after the execution of the operation (close door/door closed). The type of operation can vary by client MO1, MO2. For example, the invention supports an elevator control that allows access to certain floors only for client MO1, MO2.

While connecting to a mobile radio terminal MO1, MO2, the authentication master AEG can check if other mobile radio terminals MO1, MO2 are within its transmission/reception range BER and establish simultaneously one separate connection for each of several authorized mobile radio terminals MO1, MO2.

Preferably, the authentication master AEG changes the name NA1, NA2 and the connected operation TA1′, TA2′ after a successful connection setup and operation of the actuator. Thus, the name NA1′ “close door” could be applied after a successful door opening, the connected operation TA1′ being the closing of the door. The name NA1, NA2 can be adjusted in relation to the actuator's most recently performed operation.

If the connection setup is cancelled by the client MO1, MO2, no operation is performed.

Basically, additional software can certainly be installed on a client MO1, MO2 in order to enhance the authentication security. After successful connection setup between authentication master AEG and the client MO1, MO2 the connection could be retained and the entry of a user PIN requested.

Especially Bluetooth, ZigBee, or Wi-Fi radio standards are suitable for the application of the means according to the invention. Below, the specific radio standards—familiar to the professional—will be discussed briefly.

Bluetooth is a standardized, cost efficient technology for the radio submission of data. A Bluetooth system includes: radio components, link controller, link manager. Bluetooth devices recognize each other automatically and establish network connection. The data is submitted from one adapter to the other with a carrier frequency of 2.4 GHz (ISM-Band), as the data has no preferential direction and can be received by virtually any device. Bluetooth operates with a spread-spectrum-modulation combined with frequency-hopping (1,600 frequency hops per second). Between 2.402 GHz and 2.480 GHz 79 usable hopping frequencies in 1 MHz distance are available. A unique ID plus data encryption ensures that only devices that are authorized can communicate with each other. The maximum data rate is currently up to 1 Mbit/s and the range is restricted to currently 100 meters (328 feet). The operating system has to fulfill certain requisites, including the recognition of Bluetooth hardware, connection setup, and secure data transfer, in order to utilize full Bluetooth functionality.

As soon as Bluetooth devices are operational, the individual Bluetooth controllers identify each other within two seconds by an individual and unmistakable 48-bit long serial number. In standby unconnected devices check for messages every 1.28 seconds, thereby controlling 32 hop frequencies. A connection can be initiated by any device, thus raising itself to a master. Contact with the slaves is established by an inquiry-message and then a page-message if the hardware address of the device is unknown. If the address is known, this first step is omitted. In page-mode the master transmits 16 identical page-telegrams on 16 different hopping frequencies that are destined for the slaves. Afterwards the stations are in a “connected” status. On average, a connection is established within 0.6 seconds.

Wi-Fi (WLAN) 802.11x is a wireless data transmission protocol which was developed to design high speed Ethernets without cables. It is a so called open standard, operating on a frequency of 2.4 GHz and 13 channels (in Europe), 11 channels (in the U.S.). Like Bluetooth this standard is also licensing free. The Wi-Fi channels overlap partly, resulting in a reduction of the transmission rate. The 802.11b standard supports a bandwidth of 11 Mbit/s, the version 802.11g even 54 Mbit/s. In future, up to 320 Mbit/s will be achieved. WEP (64 or 128 bit keys) or WPA (128 bit key and an up to 63 characters long password) are available as encryption possibilities.

ZigBee IEEE 802.15.4 enables to connect household appliances, sensors and many other devices over short distances (10 to 75 meters, 33 to 246 feet). It is a stack protocol following the OSI-model and based on the OSI-sublevels PFY and MAC specified by the IEEE standard 802.15.4. It is intended for use in battery-free, maintenance-free radio switches and radio sensors in hard to reach areas, which would complicate the exchange of batteries.

There are three different types of ZigBee devices:

End Device: Simple devices, such as a light switch, implement only a part of the ZigBee protocols and are therefore also known as RFD (reduced function devices). They log on to a router of their choice and build a star network together.

Router: FFD (full function devices) can act as router, log on to an existing router and build a tree network together; by exploiting abbreviations sometimes also a mesh network.

Coordinator: Exactly one router within a PAN takes over additionally the role of coordinator. It provides basic parameters of the PAN and manages the net.

A brief example will demonstrate a version of the innovation employing Bluetooth.

A client MO1, MO2, whose Bluetooth address (=serial number=identification number ID1, ID2) is cleared at the authentication master AEG, enters into the range of the Bluetooth radio signal of the authentication master AEG. It recognizes the client MO1, MO2 and initiates an authentication process.

The name of the Bluetooth connection (=name NA1, NA2 of the authentication master AEG) is changed by the authentication master AEG according to which operation shall be confirmed by the client MO1, MO2.

If a door should be opened, the name NA1, NA2 of the Bluetooth connection will be “open door” and vice versa.

The client MO1, MO2 has to confirm this authentication process “open door” or cancel.

After the confirmation the Bluetooth master AEG cancels the connection and performs the operation “open door”.

If the connection request “open door” is canceled by the client MO1, MO2, no operation is performed.

Any desired number of clients MO1, MO2 can perform these operations at the same time.

In summary, the invention is able to create a system for authorization, access, and control, thus enabling the implementation of easy access control with the help of a regular wireless radio interface, such as Bluetooth.

The novelty of this invention is the recognition if the client is authorized without running software on the clients and that an operation can be executed—if desired—without additional action on behalf of the user.

The security of the system can further be enhanced by adding an operation or PIN entry for the client. The following applications are only examples of a large spectrum of diverse application possibilities:

Every variety of opening procedures for one or more users (e.g. door, garage, gate . . . )

Car door/window/sunroof opener for one or more users;

Authentication for security systems (hard and software based);

Registration of people flows;

Entry control with or without monitoring and

every variety of switching initiated by a client.

1. A method for authentication of at least one mobile radio terminal by means of an authentication terminal, wherein the at least one mobile radio terminal features an identification number and the identification number of the at least one mobile radio terminal is stored at the authentication terminal and as soon as a mobile radio terminal enters into the transmission/reception range of the authentication terminal, the authentication terminal scans by way of radio and checks if the identification number of the mobile radio terminal matches the saved identification number, and wherein at least one name is assigned to the identification number of the at least one mobile radio terminal at the authentication terminal and the authentication terminal when scanning or checking if the identification number of the mobile radio terminal matches the stored identification number initiates a connection setup with the mobile radio terminal in case of a match under the assigned name of the identification number, whereby the name is displayed on the mobile radio terminal and the authentication terminal cancels the connection setup as soon as the at least one mobile radio terminal confirms the connection setup with the authentication terminal under one of the displayed names.

2. The method according to claim 1, wherein after confirmation of the connection setup by the mobile radio terminal an actuator is operated.

3. The method according to claim 2, wherein said name describes an operation to be performed by the actuator.

4. The method according to claim 2, wherein said name is changed in connection with the most recently performed operation of the actuator.

5. The method according to claim 1, wherein said identification number is a unique device number assigned by the manufacturer.

6. The method according to claim 1, wherein said authentication terminal checks if other mobile radio terminals are within its transmission/reception range during the connection setup to the at least one mobile radio terminal.

7. The method according to claim 1, wherein said authentication terminal establishes simultaneously one separate connection for each of several mobile radio terminals.

8. The method according to claim 1, wherein a Bluetooth, ZigBee, or Wi-Fi radio standard is utilized for execution of the means.

9. A system for authentication of at least one mobile radio terminal by means of an authentication terminal, whereby the at least one mobile radio terminal featuring an identification number and the identification number of the at least one mobile radio terminal is stored at the authentication terminal and the authentication terminal is set-up to scan by way of radio and check if the identification number of the mobile radio terminal matches the saved identification number as soon as a mobile radio terminal enters into the transmission/reception range of the authentication terminal, wherein at least one name is assigned to the identification number of the at least one mobile radio terminal at the authentication terminal and furthermore, the authentication terminal is set-up to initiate a connection setup with the mobile radio terminal in case of a match under the assigned name of the identification number when scanning or checking if the identification number of the mobile radio terminal matches the stored identification number, and wherein the mobile radio terminal is set-up to display the name on the mobile radio terminal and the authentication terminal is also set-up to cancel the connection setup as soon as the at least one mobile radio terminal confirms the connection setup with the authentication terminal under one of the displayed names.

10. The system according to claim 9, wherein the system is set-up to operate an actuator after confirmation of the connection setup by the mobile radio terminal.

11. The system according to claim 10, wherein said name describes an operation to be performed by the actuator.

12. The system according to claim 10, wherein the system is set-up to change the name in connection with the most recently performed operation of the actuator.

13. The system according to claim 9, wherein said identification number is a unique device number assigned by the manufacturer.

14. The system according to claim 9, wherein said authentication terminal checks if other mobile radio terminals are within its transmission/reception range during the connection setup to the at least one mobile radio terminal.

15. The system according to claim 9, wherein said authentication terminal is set-up to establish simultaneously one separate connection for each of several mobile radio terminals.

16. The system according to claim 9, wherein said authentication terminal and the at least one mobile radio terminal are set-up to exchange data following the Bluetooth, ZigBee, or Wi-Fi radio standard.

17. The method according to claim 3, wherein said name is changed in connection with the most recently performed operation of the actuator.

18. The system according to claim 11, wherein the system is set-up to change the name in connection with the most recently performed operation of the actuator.
